(19) United States
(12) Patent Application Publication
(10) Pub. No.: US 2025/0357026 A1
(43) Pub. Date: Nov. 20, 2025

(54) Cable Grommet

(71) Applicant: Illinois Tool Works Inc., Glenview, IL (US)

(72) Inventors: Gerit Vollmer, Linden (DE); Albert Sbongk, Niederstetten (DE)

(21) Appl. No.: 19/210,115

(22) Filed: May 16, 2025

(30) Foreign Application Priority Data
May 17, 2024 (DE) 10 2024 113 968.4
Apr. 28, 2025 (DE) 10 2025 116 236.0

(51) Int. Cl. H01B 17/58; H01B 19/00

(52) U.S. Cl. CPC H01B 17/583; H01B 19/00

(57) ABSTRACT

According to the disclosure, a cable grommet consisting of two identical carrier bodies is provided. The carrier bodies each comprise an approximately funnel-shaped base body formed from a soft component, and a clamping element formed from a hard component, wherein the carrier bodies can be connected to one another by means of the clamping element along a connecting face in order to form the cable grommet.

### RELATED APPLICATIONS

The present application claims the benefit of German Patent Application Nos. 10 2024 113 968.4, filed May 17, 2024, and 10 2025 116 236.0, filed Apr. 28, 2025, each titled “Cable Grommet,” the contents of which are hereby incorporated by reference.

### BACKGROUND

Cable grommets are used in order to seal one or more cables of a cable strand against a support component, in particular a motor vehicle. Cable grommets are typically formed integrally from a soft component and comprise a through-opening extending in the mounting direction for sealingly abutting against one or more cables of a cable strand.

### SUMMARY

The present disclosure relates generally to a cable grommet, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1a illustrates a first known cable grommet in a perspective view.

FIG. 1b illustrates a second known cable grommet in a cross-sectional view.

FIG. 1c illustrates a third known cable grommet in a cross-sectional view.

FIG. 2 illustrates a schematic perspective side view of a carrier body of a first embodiment of the cable grommet according to the disclosure.

FIG. 3 illustrates a further schematic perspective front view of the carrier body of the first embodiment of the cable grommet according to the disclosure.

FIG. 4 illustrates a schematic side view of the carrier body of the first embodiment of the cable grommet according to the disclosure.

FIG. 5 illustrates a schematic perspective detail view of a snap-in pin of the catching element arranged on the clamping element and a groove-like connecting face of the cable grommet shown in FIG. 2 for connecting two carrier bodies.

FIG. 6 illustrates a schematic perspective view of a snap-in receiver, arranged on the clamping element, of a spring-like connecting face of the cable grommet shown in FIG. 2.

FIG. 7 illustrates a further schematic perspective view of the groove-like connecting face of the carrier body.

FIG. 8 illustrates a further schematic perspective detail view of the cover portion according to the disclosure and its interface of the carrier body.

FIG. 9a illustrates a representation of a second embodiment of two corresponding carrier bodies of the cable grommet according to the disclosure, in a schematic perspective view, prior to assembly.

FIG. 9b illustrates a representation of the second embodiment of two corresponding carrier bodies of the cable grommet according to the disclosure, in a top plan view, prior to assembly.

FIG. 10a illustrates a carrier body of the cable grommet of FIGS. 9a and 9b in a front view.

FIG. 10b illustrates the carrier body of the cable grommet of FIGS. 9a and 9b in a side view.

FIG. 10c illustrates the carrier body of the cable grommet of FIGS. 9a and 9b in a top view.

FIG. 11a illustrates a schematic perspective detail view of the carrier body's groove-like connecting face and snap-in pin.

FIG. 11b illustrates a schematic perspective detail view of the carrier body's spring-like connecting face and snap-in receiver.

FIG. 11c illustrates a schematic perspective detail view of the carrier body's fastening catch.

FIG. 11d illustrates a schematic perspective detail view of the carrier body's snap-in receiver and cover portion.

FIG. 11e illustrates a schematic perspective detail view of the carrier body's spring of the spring-like connecting face with arranged protrusion/lip.

FIG. 11f illustrates a schematic perspective detail view of the carrier body's groove of the groove-like connecting face with arranged recess.

FIG. 12a illustrates a schematic perspective representation of the base body formed from a soft material.

FIG. 12b illustrates a schematic perspective representation of a clamping element formed from a hard material.

FIG. 13a illustrates a schematic perspective cross-sectional view of the carrier body along the A-A cross-sectional plane.

FIG. 13b illustrates a schematic perspective cross-sectional view of the carrier body along the B-B cross-sectional plane.

### DETAILED DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y, and/or z” means “one or more of x, y, and z.”

The present disclosure relates to a cable grommet, in particular for sealing one or more cables of a cable strand against a support component, for example, a motor vehicle.

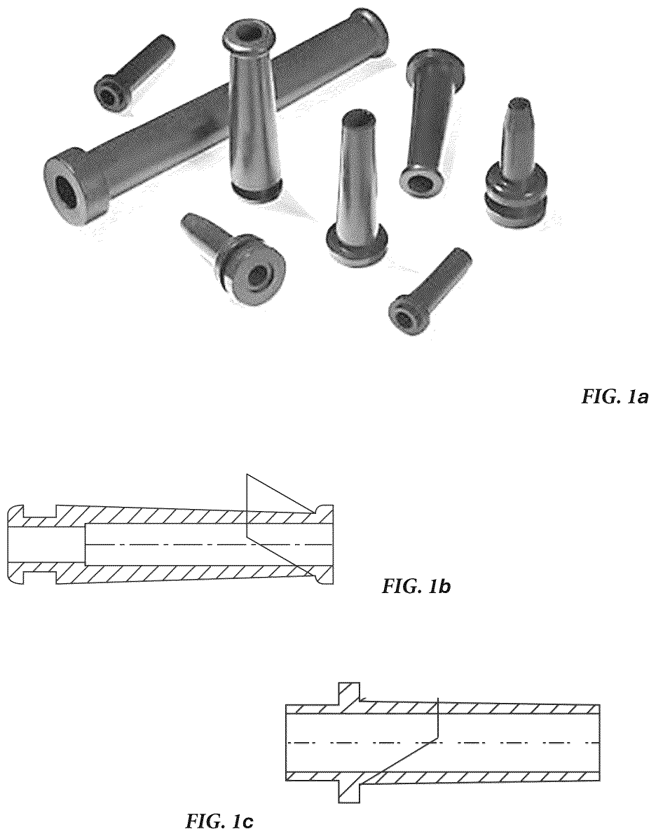

FIG. 1a illustrates a first known cable grommet in a perspective view, while FIGS. 1b and 1c illustrate second and third known cable grommet in cross-sectional views. As illustrated, these cable grommets are mostly one-piece or integral. In order to arrange such cable grommets on one or more cables of a cable strand, an automated production and/or mounting process would need to be interrupted in order to thread one or more cables through a corresponding through-opening of such a cable grommet or to arrange the cable grommet on one or more cables. This costs time and additional resources.

The object of the present disclosure is to provide a cable grommet that is easy to mount. A further object of the present disclosure is to provide a cable grommet that offers an alternative to the cable grommets known from the prior art. An additional object of the present disclosure is to provide a cable grommet that is simply constructed as well as safe and reliable in operation.

According to the disclosure, a cable grommet consisting of two identical carrier bodies is provided. The carrier bodies each comprise an approximately funnel-shaped base body formed from a soft component, and a clamping element formed from a hard component, wherein the carrier bodies can be connected to one another by means of the clamping element along a connecting face in order to form the cable grommet.

By providing a two-part cable grommet configured according to the disclosure, it can be arranged on one or more cables of a cable strand without having to interrupt a corresponding manufacturing and/or mounting process.

Thus, during an automated process, the cable grommet according to the disclosure can be arranged on one or more cables of a cable strand at any desired position without having to interrupt the process, due to the fact that it is formed from two identical carrier bodies that can be connected to one another.

In particular, the present disclosure is wherein the cable grommet is formed from two identical carrier bodies, so that only a single tool is necessary for manufacturing the two carrier bodies. This can significantly reduce manufacturing costs.

Furthermore, such a two-part cable grommet provides an alternative to cable grommets known from the prior art.

The cable grommet according to the disclosure is also extremely simple in design, because the two carrier bodies can be simply connected to one another by means of a clamping element. Thus, no special tools or knowledge are required for assembly.

The base body can comprise a funnel-shaped portion, wherein an annular disk-shaped flange portion that extends approximately orthogonally to a mounting direction is molded on a flared end of the funnel-shaped portion, and wherein a tangentially circumferential sealing element that extends in the mounting direction for sealing against a support component is molded on the flange portion.

The sealing element can be configured in the manner of an O-ring.

By means of the sealing element, a sealing of the cable grommet against a support component is possible. An O-ring sealing element is described, but sealing elements configured differently, such as sealing lips, can also be provided.

A tangentially circumferential, lip-like cover portion extending approximately in the mounting direction and formed from a hard component can be provided in the edge region of the flange portion for protecting the sealing element when the cable grommet is struck by water during operation or during a corresponding pressure washer test.

The cover portion is thus provided in order to prevent water from penetrating from the outside into the cable grommet and thus also into a corresponding support component in which the cable grommet is arranged. In particular, the cover portion meets the requirements for corresponding pressure water testing.

The cover portion can protrude orthogonally to the mounting direction on a side of the connecting face opposite the base body and is offset from the base body on the other side of the connecting face by the same length, so that a separation plane of the cover portion is offset radially from a separation plane of the sealing element, so that the cover portion covers the interface of the sealing element.

Due to the fact that the cover portion is offset in relation to a separation plane of the sealing element or is arranged so as to overlap it, a penetration of water into the cable grommet according to the disclosure is avoided even more safely and reliably, because the separation planes of the cover portion and the sealing element are offset from one another. This therefore makes a penetration of water into the cable grommet significantly more difficult.

The cover portion can furthermore be a component part of the clamping element or can be integrally connected thereto.

On its free ends extending orthogonally to the mounting direction, the clamping element can comprise catching means configured so as to correspond to one another.

The two carrier bodies can be easily and reliably connected to a cable grommet via the catching means of the clamping element.

In addition, the base portions formed from a soft component can be subjected to a compressive force acting in the radial direction, for example, in order to sealingly connect the two carrier bodies to one another.

The connecting face of the base body can comprise a first connecting face forming a groove and a second connecting face forming a spring, which are configured so as to engage correspondingly with one another.

The groove-like and spring-like connecting faces allow a sealing connection of the two carrier bodies with one another, in particular by overlapping.

The spring of the first connecting face can have a slight oversize in relation to the groove of the second connecting face, so that the two carrier bodies can be sealingly connected to one another by means of a press fit.

Alternatively, the spring of the first connecting face can have a protruding lip and the groove of the second connecting face has a corresponding recess, so that the two carrier bodies can be sealingly connected to one another by means of a form fit.

Advantageously, the groove of the second connecting face can be formed by the clamping element in conjunction with the base body, and the spring of the first connecting face can be formed by the clamping element.

Alternatively, the first and the second connecting faces can also be configured so as to correspond to one another and to allow a connection with or without adhesive.

An additional bonding of the sealing surfaces ensures a better seal and a better retention of the two carrier bodies of the cable grommet over the entire service life.

Furthermore, catching elements extending in the mounting direction can be arranged on the clamping element in order to connect the cable grommet to a wall that delimits a through-opening of a support component.

In addition, for sealingly abutting against a cable, an end opposite the flared end of the base body is configured so as to be conically shaped approximately in the mounting direction, wherein this region is referred to as the cable sealing portion, and wherein the cable sealing portion can be optionally wrapped by means of a tape, in particular an adhesive tape for sealing abutment on a cable, wherein a bead can be optionally molded on the free end of the cable sealing portion in order to secure the tape against slipping, and/or a catching connection is provided in this region.

By means of the devices described above, a sealing of the cable sealing portion against one or more cables of a cable strand can be significantly improved and increased.

In addition, according to the present disclosure, a method for manufacturing a cable grommet as described above is provided. The cable grommet can be manufactured from a hard component and a soft component by means of a two-component injection-molding process, in particular in a single manufacturing apparatus.

For example, the two carrier bodies of the cable grommet according to the disclosure can be manufactured from two different plastics or from a soft component and a hard component in a single manufacturing device.

As the hard component, PA or PA66 can be provided, for example.

As the soft component, TPE, TPV, or also TPS can be provided, for example.

In addition, according to the present disclosure, a method for mounting a cable grommet according to the present disclosure is provided, wherein, during an automated process for producing a cable strand, the cable grommet can be connected at almost any point in time to the cable strand by arranging and subsequently connecting the carrier bodies of the cable grommet on both sides.

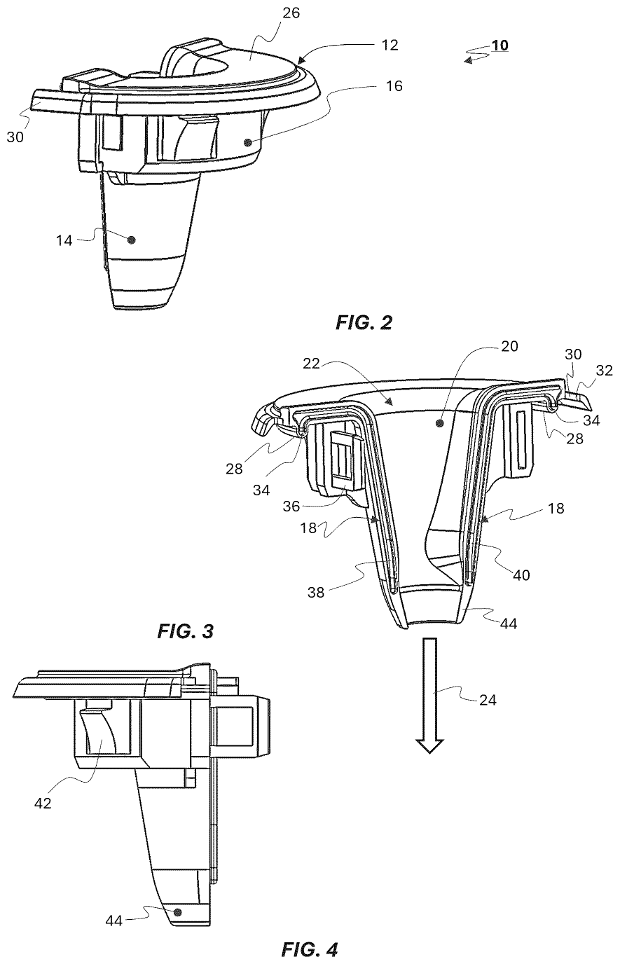

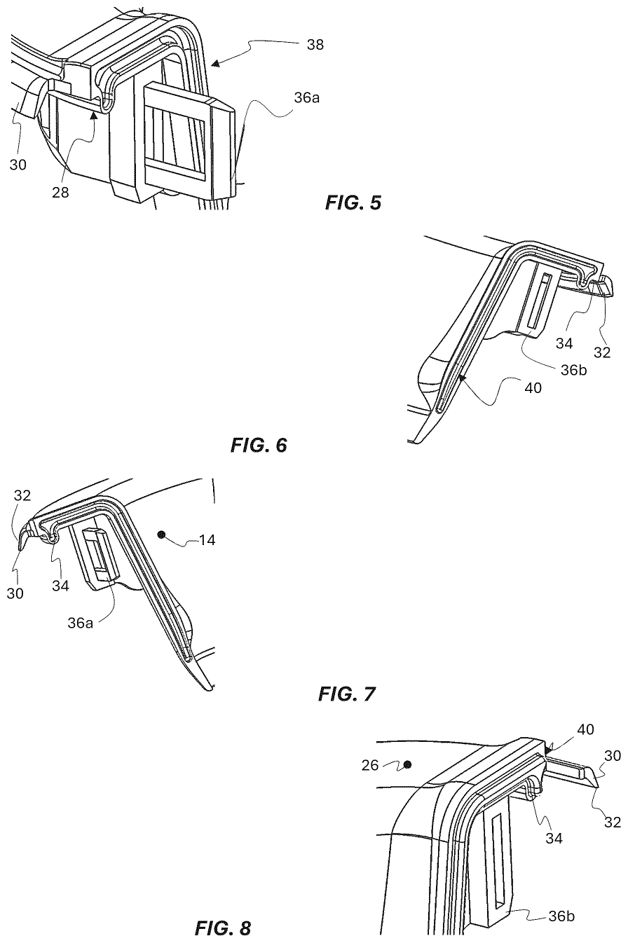

A first example of a cable grommet 10 according to the disclosure is formed from two identical or uniform carrier bodies 12 is illustrated in FIGS. 2-8. Specifically, FIG. 2 illustrates a schematic perspective side view of a carrier body of a first embodiment of the cable grommet according to the disclosure. FIG. 3 illustrates a further schematic perspective front view of the carrier body of the first embodiment of the cable grommet according to the disclosure. FIG. 4 illustrates a schematic side view of the carrier body of the first embodiment of the cable grommet according to the disclosure. FIG. 5 illustrates a schematic perspective detail view of a snap-in pin of the catching element arranged on the clamping element and a groove-like connecting face of the cable grommet shown in FIG. 2 for connecting two carrier bodies. FIG. 6 illustrates a schematic perspective view of a snap-in receiver, arranged on the clamping element, of a spring-like connecting face of the cable grommet shown in FIG. 2. FIG. 7 illustrates a further schematic perspective view of the groove-like connecting face of the carrier body. FIG. 8 illustrates a further schematic perspective detail view of the cover portion according to the disclosure and its interface of the carrier body.

The cable grommet 10 is provided for receiving one or more cables of a cable strand (not shown) in order to arrange them in a sealing manner in a support component (not shown), for example a motor vehicle.

The two carrier bodies 12 are thus configured as half-shells that can be connected to one another in order to form the cable grommet 10.

The carrier body 12 comprises an approximately funnel-shaped base body 14 formed from a soft component, and a clamping element 16 formed from a hard component. The two carrier bodies 12 can be sealingly connected to one another by means of the clamping element 16 along a connecting face 18 in order to completely form the cable grommet 10.

The base body 14 comprises a funnel-shaped portion 20. The funnel-shaped portion 20 comprises a flared end 22.

An annular disk-shaped flange portion 26 extending approximately orthogonally to a mounting direction 24 is molded on the flared end 22. The flange portion 26, which is a component of the base body 14, is thus also formed from a soft component, wherein a tangentially circumferential sealing element 28 extending in the mounting direction 24 is molded on the flange portion 26. The sealing element 28 is configured in the manner of an O-ring seal and is thus approximately circular in cross-section (like a sealing bead) at least in the region in which it abuts a support component.

The clamping element 16 formed from a hard component comprises a flange portion corresponding to the flange portion 26 of the base body 14, which flange portion comprises a lip-like cover portion 30 extending tangentially circumferentially on the outer edge region and approximately in the mounting direction 24 and formed from a hard component, which is provided for the protection of the sealing element 28 when the cable grommet 1 is struck with water, for example during a pressure washer test.

The illustrated cover portion 30 is integrally connected to the clamping element 16 or is an integral component of the clamping element 16. The cover portion 30 is configured so as to protrude orthogonally to the mounting direction 24 on a first side of the connecting face 18 opposite the base body 14 (FIGS. 3 and 8). On the other, second side of the connecting face 18, by contrast, the cover portion 30 is offset from the base body 14 by the same length (FIGS. 3, 4, and 5).

In this way, a corresponding separation surface or interface 32 of the cover portion 30 is tangentially circumferentially or radially offset from a separation line or surface 34 of the sealing element 28, so that the cover portion 30 covers the interface 34 of the sealing element 28.

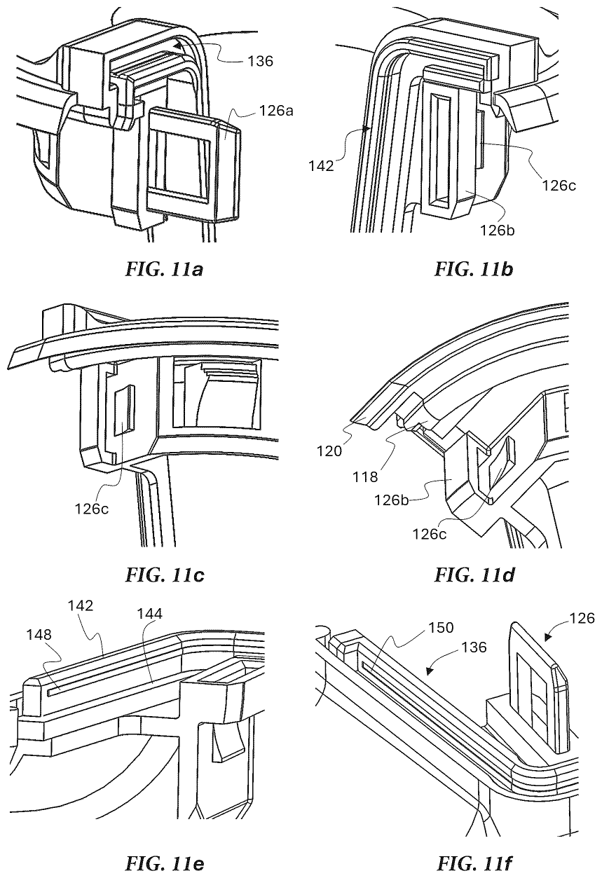

On its free ends extending orthogonally to the assembly direction 24, the clamping element 16 comprises catching means 36 configured so as to correspond to one another. The catching element 36 comprises a snap-in pin, bar, or ridge 36a and a correspondingly formed snap-in receiver 36b. The snap-in receiver 36b is further provided with a snap-in tooth securing the snap-in pin 36a (not shown, but see second exemplary embodiment in FIG. 11 (c), (d), (e)).

Because the base body 14 is formed from a soft component, it can also be provided that, in the connected state, the clamping element 16 strikes the two base bodies 14 with a compressive force acting in the radial direction inward, for example, in order to sealingly connect the two connecting faces 18.

At a free end of the base body 14 extending in the orthogonal direction, the connecting face 18 comprises a first groove-like connecting face 38 and, at the other end, a correspondingly spring-like connecting face 40. The groove-like connecting face 38 and the spring-like connecting face 40 can be configured so as to be precisely fitting such that they can be sealingly connected by means of the clamping element 16.

Alternatively, it can also be provided that the spring of the first spring-like connecting face 40 has a slight oversize in relation a groove of the second groove-like connecting face 38, so that the two carrier bodies 12 can be sealingly connected to one another by means of this press fit.

Alternatively, the spring of the first connecting face 40 can have a slight undersize in relation to the groove of the second connecting face 38. It is then provided that the two connecting faces 38, 40 are additionally connected by means of an adhesive, so that the two carrier bodies 12 can be sealingly connected to one another.

The clamping element 16 extends tangentially circumferentially around the base body 14 in the manner of a half-shell, wherein the clamping element 16 of the first embodiment of the disclosure is configured in a tape-like manner so as to connect the two catching elements 36, i.e., a snap-in pin 36a and a snap-in receiver 36b, to one another.

Furthermore, one, two, three, or more fastening catch(es) 42 extending in the mounting direction 24 are molded on the clamping element 16 in order to connect the cable grommet 10 to a wall that delimits a through-opening of a support component.

A cable sealing portion 44 is provided at an end opposite the flared end 22 of the base body 14. The cable sealing portion 44 for sealing abutment against one or more cables is configured so as to be approximately conical in the mounting direction 24. The conical cable sealing portion 44 can alone be sufficient for sealing abutment against one or more cables.

In order to additionally improve a corresponding sealing effect with respect to one or more cables, it can also be provided that a tape, in particular a wrapping by means of adhesive tape, is provided radially circumferentially on the outer side of the cable sealing portion 44.

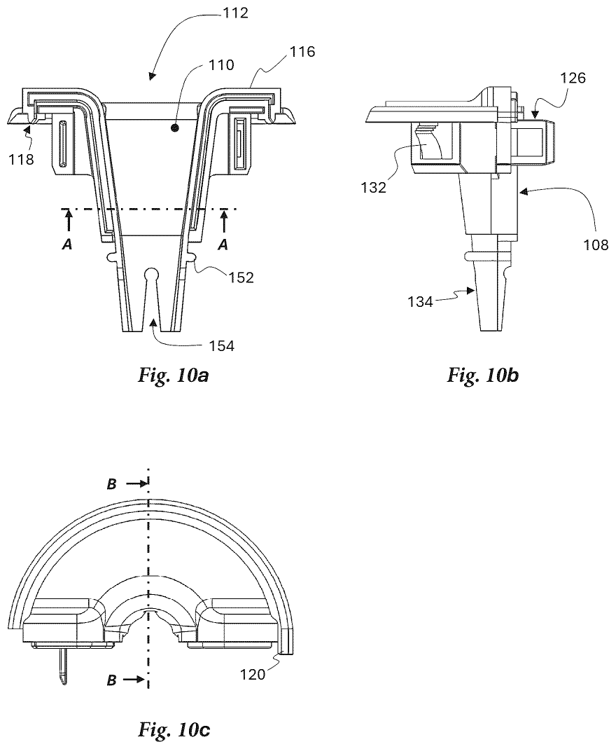

Furthermore, a bead-shaped portion can be molded at the free end of the cable sealing portion 44 (not shown, but see second embodiment in FIG. 10) in order to prevent a corresponding tape or adhesive tape from slipping over the service life.

In addition and/or alternatively, the two half-shells of the base body 14 in the region of the cable sealing portion 44 can also comprise corresponding catching means in order to improve the sealing effect and/or to connect the two halves and/or the two carrier bodies 12 of the cable grommet 10 to one another.

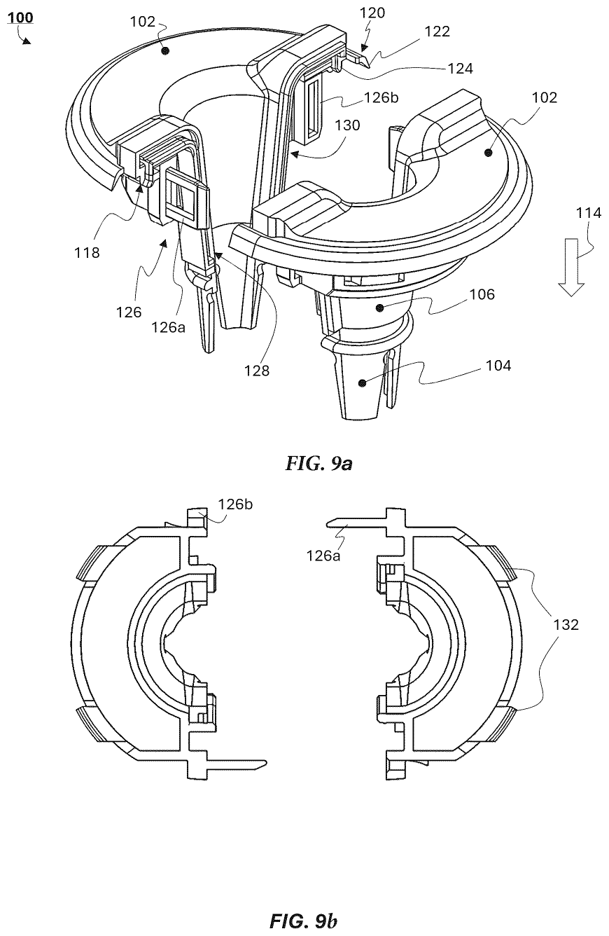

A second embodiment 100 of the disclosure is shown in FIGS. 9a through 13b and corresponds to the essential features of the first embodiment. Relevant differences are described in further detail below.

FIGS. 9a and 9b show the two identical carrier bodies 102 of the cable grommet 100 prior to assembly on a cable or cable strand, i.e., the two base body halves 102 are still arranged separately and opposite one another. The carrier body comprises in each case a base body 104 formed from a soft material (e.g., an elastomer) and a clamping element 106 shaped from a hard material (e.g., a thermoplastic, such as a polyamide) that partially surrounds the base body 104 and is partially penetrated by the base body in an engaging manner.

FIG. 10a illustrates a carrier body of the cable grommet of FIGS. 9a and 9b in a front view, while FIGS. 10b and 10c illustrate the carrier body in a side view and in a top view. As can be seen, the clamping element 106 is extended axially towards the distal end (i.e., towards the conical end) compared to the first embodiment (see FIG. 2). The axially extended clamping element 106, together with the soft base body 104, forms in each case the groove-like connecting face 128 and the spring-like connecting face 130. The groove-like connecting face 128 comprises a groove 136 formed by an inner edge 138 of the base body 104 protruding orthogonally to the mounting direction 114 and an outer edge 140 of the clamping element 106 protruding orthogonally to the mounting direction 114, wherein the outer edge 140 protrudes orthogonally to the mounting direction 114 opposite the inner edge 138. An edge region of the clamping element 106 forms a spring 142 corresponding to the groove 136 on the spring-like connecting face 130. The spring 142 is struck on the inner and outer sides with an inner 144 and outer edge 146 of the base body 104 that are respectively offset orthogonally to the mounting direction 114. The offsetting of the respective inner and outer edges 144, 146 of the base body 104 corresponds to the protruding offset between the inner 138 and outer edge 140 of the groove 136 of the groove-like connecting face 128.

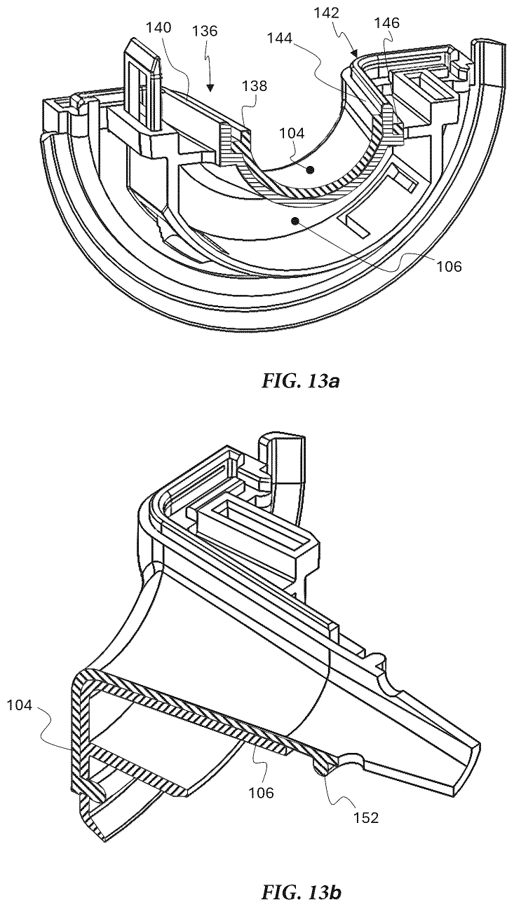

FIGS. 11a-11f illustrate schematic perspective detail views of various components of the carrier body. FIG. 11a shows the groove-like connecting face and snap-in pin; FIG. 11b shows the spring-like connecting face and snap-in receiver; FIG. 11c shows the fastening catch; FIG. 11d shows the snap-in receiver and cover portion; FIG. 11e shows the spring of the spring-like connecting face with an associated protrusion/lip; and FIG. 11f shows the groove of the groove-like connecting face with an associated recess. FIGS. 13a and 13b illustrate schematic perspective cross-sectional views of the carrier body, taken along the A-A and B-B planes, respectively.

In the example shown, the spring 142 comprises a longitudinally oriented protruding lip 148 which can engage in a form-fit manner with a corresponding recess 150 arranged longitudinally on the inner side of the outer edge of the groove 136.

Due to the correspondingly offset edges of the connecting faces 128, 130 to be connected, the combination of the soft base body 104 and the hard clamping element 106 for forming the groove-like 128 and the spring-like connecting face 130, and the additionally arranged lip 148 and corresponding recess 150, the sealing quality and holding force of the connection of the two-piece cable grommet 100 is significantly improved when the two carrier bodies 102 are joined together.

According to the first embodiment of the cable grommet 10, the clamping element 106 of the second embodiment 100 extends tangentially circumferentially around the base body 104 in the manner of a half-shell, wherein catching elements 126, each having a snap-in pin 126a and a snap-in receiver 126b (see FIGS. 11a through 11f), are formed on the free ends. The snap-in receiver further comprises a snap-in tooth 126c that locks the snap-in pin 126a in the connected state.

Furthermore, one, two, three, or more elastically deflectable fastening catch(es) 132 extending in the mounting direction 114 are molded on the clamping element 106 in order to connect the cable grommet 100 to a wall that delimits a through-opening of a support element.

A cable sealing portion 134 is provided at an end opposite the flared end 112 of the base body 104. The cable sealing portion 134 for sealing abutment against one or more cables is configured so as to be approximately conical in the mounting direction 114. The conical cable sealing portion 134 can alone be sufficient for sealing abutment against one or more cables. In order to additionally improve a corresponding sealing effect with respect to one or more cables, it can also be provided that a tape, in particular a wrapping by means of adhesive tape, is provided radially circumferentially on the outer side of the cable sealing portion 134. At the free end of the cable sealing portion 134 of the second embodiment, a bead-shaped portion or a bead 152 is further molded in order to prevent a corresponding tape or adhesive tape from slipping over the service life. To improve the adaptability of the soft base body 104 to various diameters of the cables or cable strands, the cable sealing portion 134 comprises a slot 154 extending axially from the distal end to the bead 152.

In addition, according to the present disclosure, a method for manufacturing a cable grommet as described above is provided. The cable grommet can be manufactured from a hard component and a soft component by means of a two-component injection-molding process, in particular in a single manufacturing apparatus.

For example, the two carrier bodies of the cable grommet according to the disclosure can be manufactured from two different plastics or from a soft component and a hard component in a single manufacturing device.

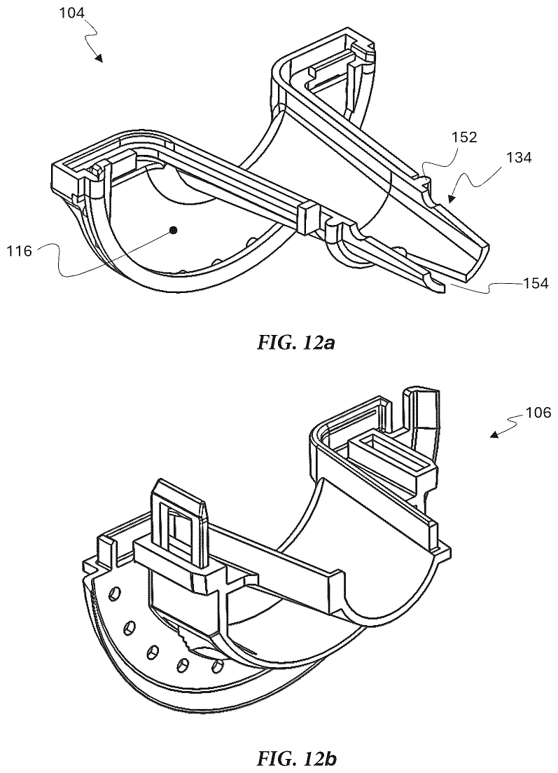

FIGS. 12a and 12b illustrate schematic perspective views of two components: FIG. 12a shows the base body formed from a soft material, while FIG. 12b shows a clamping element formed from a hard material. As the hard component, PA or PA66 can be provided, for example. As the soft component, TPE, TPV, or also TPS can be provided, for example.

The hard component (clamping element 106) is also equipped with holes in the flange portion (see FIG. 12b), so that the soft component (base body 104) connects in a form-fit manner to the hard component during manufacture and encloses it on both sides.

In addition, according to the present disclosure, a method for mounting a cable grommet 10, 100 according to the present disclosure is provided, wherein, during an automated process for producing a cable strand, the cable grommet 10, 100 can be connected at almost any point in time to the cable strand by arranging and subsequently connecting the carrier bodies 12, 102 of the cable grommet 10, 100 on both sides.

While the present method and/or system has been described with reference to certain implementations, it will be understood by those skilled in the art that various changes may be made, and equivalents may be substituted without departing from the scope of the present method and/or system. In addition, many modifications may be made to adapt a particular situation or material to the teachings of the present disclosure without departing from its scope. For example, block and/or components of examples disclosed may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

List of reference numerals

| | |
|---|---|
| 10 | Cable grommet, first design |
| 12 | Carrier body |
| 14 | Base body |
| 16 | Clamping element |
| 18 | Connecting face |
| 20 | Funnel-shaped portion |
| 22 | Flared end |
| 24 | Mounting direction |
| 26 | Flange portion |
| 28 | Sealing element |
| 30 | Cover portion |
| 32 | Interface of separation plane of the cover portion |
| 34 | Separation line of sealing element |
| 36 | Catching element |
| 36a | Snap-in pin |
| 36b | Snap-in receiver |
| 38 | Groove-like connecting face |
| 40 | Spring-like connecting face |
| 42 | Fastening catch |
| 44 | Cable sealing portion |
| 100 | Cable grommet, second design |
| 102 | Carrier body |
| 104 | Base body |
| 106 | Clamping element |
| 108 | Connecting face |
| 110 | Funnel-shaped portion |
| 112 | Flared end |
| 114 | Mounting direction |
| 116 | Flange portion |
| 118 | Sealing element |
| 120 | Cover portion |
| 122 | Interface of separation plane of the cover portion |
| 124 | Separation line of sealing element |
| 126 | Catching element |
| 126a | Snap-in pin |
| 126b | Snap-in receiver |
| 126c | Snap-in tooth |
| 128 | Groove-like connecting face |
| 130 | Spring-like connecting face |
| 132 | Fastening catch |
| 134 | Cable sealing portion |
| 136 | Groove |
| 138 | Inner edge, groove |
| 140 | Outer edge, groove |
| 142 | Spring |
| 144 | Inner edge, spring |
| 146 | Outer edge, spring |
| 148 | Lip |
| 150 | Recess |
| 152 | Bead |
| 154 | Slot |

What is claimed is:

1. A cable grommet consisting of two carrier bodies, each of the two carrier bodies comprising:
an approximately funnel-shaped base body formed from a soft component, and a clamping element formed from a hard component,
wherein the two carrier bodies can be connected to one another by means of the clamping element along a connecting face in order to form the cable grommet.

2. The cable grommet according to claim 1,
wherein the base body comprises a funnel-shaped portion,
wherein an annular disk-shaped flange portion that extends approximately orthogonally to a mounting direction is molded on a flared end, and
wherein a tangentially circumferential sealing element that extends in the mounting direction for sealing against a support component is molded on the flange portion, and
wherein the sealing element is an O-ring.

3. The cable grommet according to claim 2, wherein a tangentially circumferential, lip-like cover portion extending approximately in the mounting direction and formed from a hard component is provided in an edge region of the flange portion for protecting the sealing element when the cable grommet is struck by water, and wherein the cover portion is a component of the clamping element.

4. The cable grommet according to claim 2, wherein the cover portion protrudes orthogonally to the mounting direction on a side of the connecting face opposite the base body and is offset from the base body on the other side of the connecting face by the same length, so that a separation plane of the cover portion is offset radially from a separation plane of the sealing element, and wherein the cover portion covers the separation plane of the sealing element.

5. The cable grommet according to claim 1, wherein on its free ends extending orthogonally to a mounting direction, the clamping element comprises catching means configured so as to correspond to one another.

6. The cable grommet according to claim 1, wherein the connecting face comprises a first connecting face forming a groove and a second connecting face forming a spring, which are configured so as to engage correspondingly with one another.

7. The cable grommet according to claim 6,
wherein the spring of the first connecting face has a slight oversize in relation to the groove of the second connecting face, so that the two carrier bodies can be sealingly connected to one another by means of a press fit, or
wherein the spring of the first connecting face has a protruding lip and the groove of the second connecting face has a corresponding recess, so that the two carrier bodies can be sealingly connected to one another by means of a form fit.

8. The cable grommet according to claim 6, wherein the groove of the second connecting face is formed by the clamping element in connection with the base body, and the spring of the first connecting face is formed by the clamping element.

9. The cable grommet according to claim 2,
wherein, for sealingly abutting against a cable, an end opposite the flared end of the base body is configured so as to be conically shaped approximately in the mounting direction, this region is referred to as a cable sealing portion,
wherein the cable sealing portion is wrapped by means of an adhesive tape for sealing abutment on a cable,
wherein a bead is molded on a free end of the cable sealing portion in order to secure the tape against slipping, and wherein a catching connection is provided in this region.

10. A method for manufacturing the cable grommet according to claim 1, wherein the cable grommet is manufactured from a hard component and a soft component by means of a two-component injection-molding process in a single manufacturing apparatus.
